(19) United States
(12) Patent Application Publication
(10) Pub. No.: US 2010/0191707 A1
(43) Pub. Date: Jul. 29, 2010

(54) TECHNIQUES FOR FACILITATING COPY CREATION

(75) Inventors: Artsiom Ivanovich Kokhan, Redmond, WA (US); Mihai Petriuc, Redmond, WA (US); Siddharth Rajendra Shah, Bothell, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/358,263

(22) Filed: Jan. 23, 2009

(51) Int. Cl. G06F 17/30

(52) U.S. Cl. 707/649; 707/E17.005; 707/E17.014

(57) ABSTRACT

Various techniques are disclosed for creating a snapshot of application data. A snapshot is taken by pausing parts of the application over time. Modifications are paused to a first part of data and the first part is copied into a snapshot. After the first part has finished copying, modifications are paused to remaining data, and the remaining data is copied. The application is unpaused. A snapshot can be taken by unpausing parts of the application over time. Modifications to data in an application are paused. A first part of data is copied, and after the first part has finished copying, modifications to the first part are unpaused. The final part of data is copied, and after the final part has finished copying, modifications to the final part are unpaused. Techniques for creating a snapshot of data residing in multiple locations are described.

### BACKGROUND

Applications generally use data that is stored in one or more databases and/or files in order to provide the desired functionality to end users. In the case of complex applications, the data for the application may reside in multiple files, databases, and/or span multiple servers. It can be difficult to take a complete snapshot of that data, such as for backup purposes or mirroring, without totally taking the application offline while the files are copied to create the snapshot.

### SUMMARY

Various technologies and techniques are disclosed for creating a snapshot of data in an application. A method is described for taking a complete snapshot of data in an application in multiple phases by pausing parts of the application over time. While an application is running, modifications are paused to a first part of data and the first part of data is copied into a snapshot. After the first part of data has finished copying and while keeping modifications to the first part of data paused, modifications are paused to remaining data that was not already copied with the first part of data, and the remaining data is copied to the snapshot. The application is resumed once the remaining data has finished copying.

A method is described for taking a complete snapshot of data in an application in multiple phases by unpausing parts of the application over time. All modifications to data in an application are paused. A first part of the data is copied, and after the copying is finished, modifications to the first part of data are unpaused. A final part of the data is copied, and after the final part of data has finished copying, then modifications to the final part of data are unpaused.

Techniques for creating a complete snapshot of an application with data residing in multiple locations are also described. A complete snapshot of data for an application is created by making a copy of the data that resides in files in multiple locations. The application is paused for a continuous period of time that includes timestamps of the copies from all of the locations.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a process flow diagram for one implementation that illustrates the stages involved in taking a complete snapshot of data in an application in multiple phases by pausing parts of the application over time.

FIG. 2 is a process flow diagram for one implementation that illustrates the stages involved in taking a complete snapshot of data in an application in two phases by pausing parts of the application over time.

FIG. 3 is a process flow diagram for one implementation illustrating the stages involved in taking a complete snapshot of data in an application in multiple phases by unpausing parts of the application over time.

FIG. 4 is a process flow diagram for one implementation illustrating the stages involved in taking a complete snapshot of data in an application in two phases by unpausing parts of the application over time.

FIG. 5 is a process flow diagram for one implementation illustrating the stages involved in creating a snapshot of an application with data residing in multiple locations.

FIG. 6 is a diagrammatic view of one implementation illustrating an exemplary adjustment process that can be used to adjust the times that files are copied to bring the timestamps of copies from the different locations closer together.

FIG. 7 is a process flow diagram for one implementation illustrating the stages involved in creating a snapshot of an application using a combination of multiple phase copying as well as multiple location copying.

FIG. 8 is a process flow diagram for one implementation illustrating the stages involved in taking a snapshot of search application data using a multi-phase copy process.

FIG. 9 is a diagrammatic view of a computer system of one implementation.

### DETAILED DESCRIPTION

The technologies and techniques herein may be described in the general context as an application that creates a snapshot of data for an application in multiple phases, but the technologies and techniques also serve other purposes in addition to these. In one implementation, one or more of the techniques described herein can be implemented as features within a backup program, or from any other type of program or service that takes a snapshot of application data at a point in time for backup, mirroring, and/or other purposes.

As described in the background section, unless an application is taken offline for the duration of a snapshot process, it can often be difficult to take an accurate snapshot of data for an application at a particular point in time, such as for backup or mirroring purposes. However, it is usually desirable to minimize the amount of time that an application is not able to perform all its intended functions. Thus, techniques are described herein to allow for a snapshot to be taken of data of an application in a manner that allows the application to remain functioning in part while some of the data is being copied. These techniques involve pausing or unpausing the application over time as the snapshot is being taken of the data.

The term “snapshot” as used herein is meant to include a copy of data used by an application at a particular point in time. The snapshot can be taken for numerous purposes, such as to create a backup of the data for the application, or to create a mirrored version of the application. The term “backup” as used herein is meant to include a copy of data used by application at a particular point in time that can be used to subsequently restore the application to that particular point in time in the event of data loss. The term “mirrored version” as used herein is meant to include an exact copy of the data used by an application that is installed in a different location to enable more users to access the application and/or improved performance to be provided in the application. The term “pausing the application” or “pausing modifications to the data” as used herein are meant to include disallowing one or more parts of the data to be modified by the application. The term “timestamp of a copy” refers to a period of time when all the files that are stored in a particular copy of application data are consistent and can be used to create a mirrored version of the data.

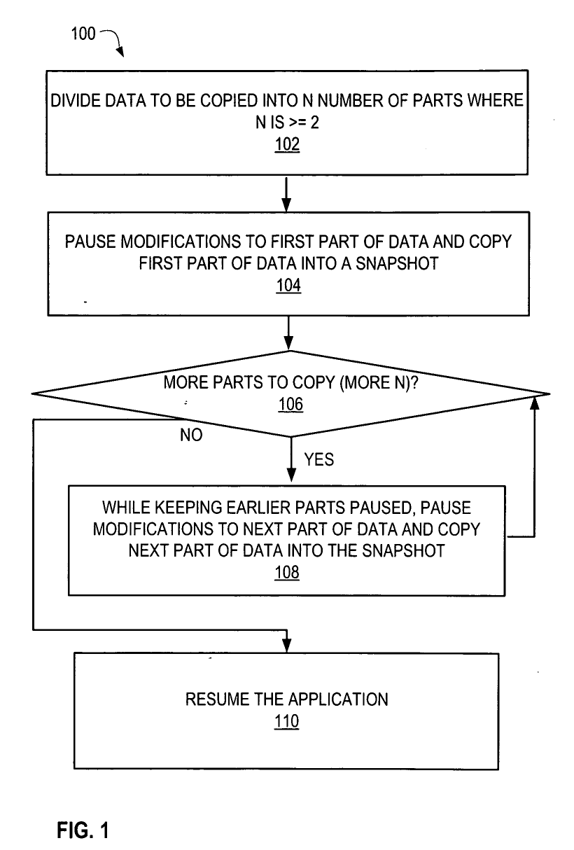

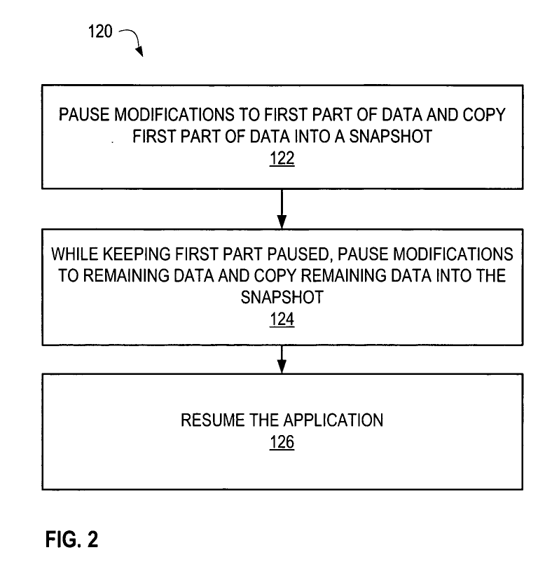

In one implementation, the snapshot is created by pausing parts of the application over time as copies of the data are being made. In such an implementation, the process starts with the application running. In each phase, modifications are paused to one part of data while that part of data is copied (while also keeping all previously paused parts paused too). In the last phase, the application is paused completely and the remaining data is copied. After all the data is copied, the application is resumed. This implementation is described in further detail in FIGS. 1-2.

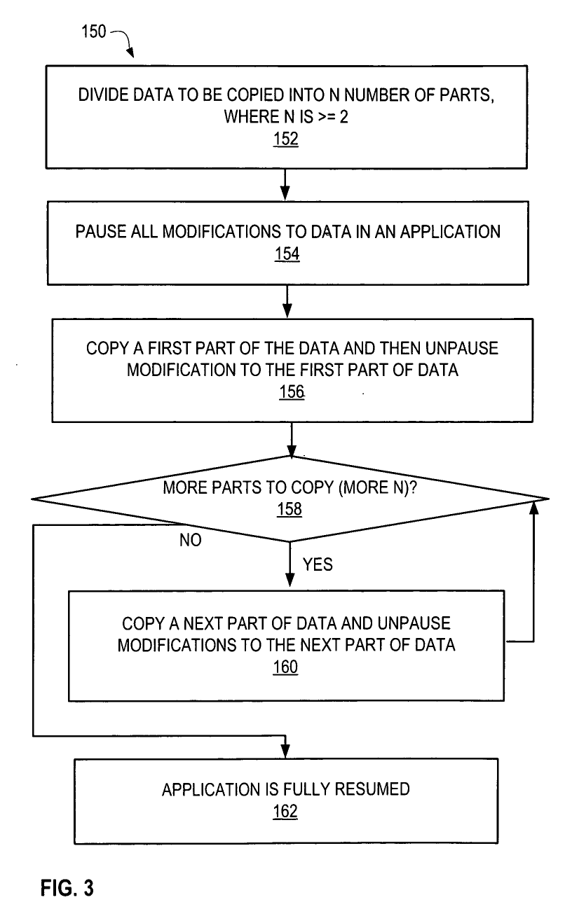

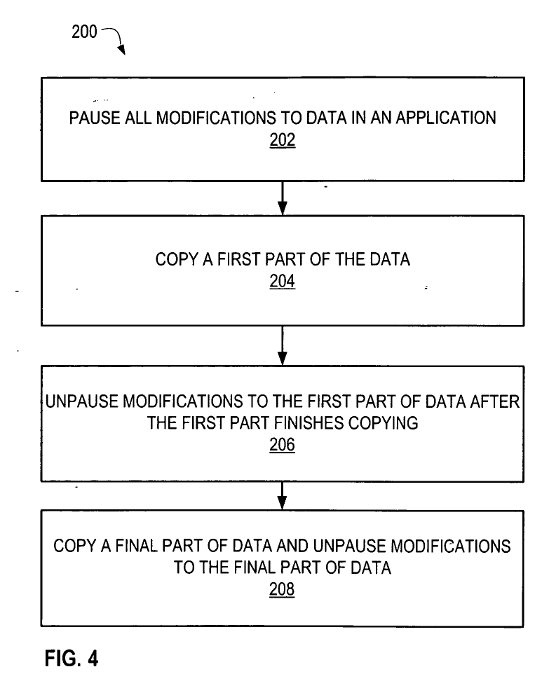

In another implementation, the snapshot is created by starting with a paused application, and then unpausing parts of the application over time as copies are being made. In such an implementation, modifications to the entire application are paused up front. Then, as each part of the data is copied, that part of the application is unpaused so that modifications can be made to the part that was just copied. In the last phase, the last paused part of the data is copied and the application is completely resumed. This implementation is described in further detail in FIG. 3-4.

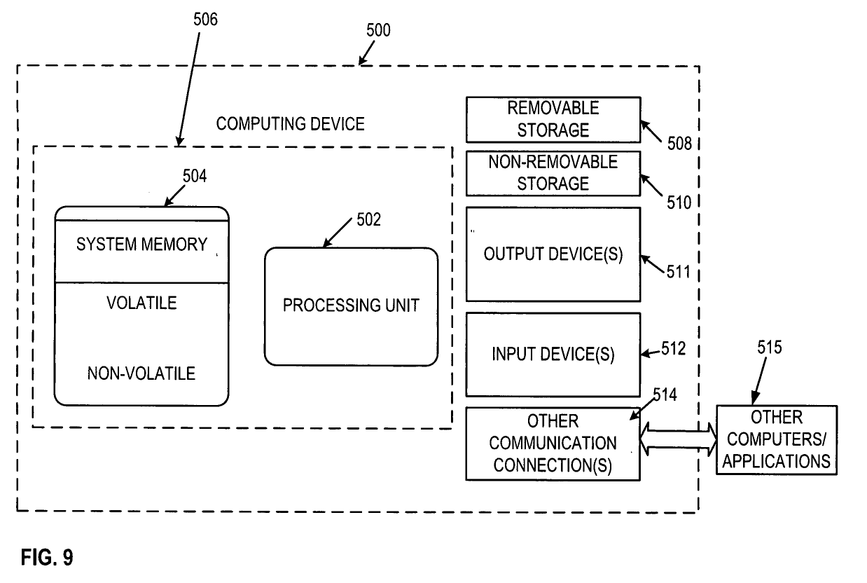

Turning now to FIGS. 1-8, the stages for implementing one or more implementations of the techniques for multi-phase copying are described in further detail. In some implementations, the processes of FIGS. 1-8 are at least partially implemented in the operating logic of computing device 500 (of FIG. 9). As one non-limiting example, the processes can be contained within one or more programs or processes that are responsible for creating a backup copy of an application at a particular point in time. As another non-limiting example, the processes can be contained within one or more programs or processes that are responsible for creating a mirrored version of an application.

FIG. 1 is a process flow diagram 100 that illustrates one implementation of the stages involved in taking a complete snapshot of data in an application in multiple phases by pausing parts of the application over time. The application can be any type of application, such as a search application. The data being copied can be contained in one or more databases, database tables, files, and/or other locations.

The data to be copied is divided into N number of parts, where N is greater than or equal to 2 (stage 102). In other words, before the copying begins, the data is segmented into the parts that will be copied together. While keeping an application running, modifications are paused to a first part of the data, and the first part of data is copied into a snapshot (stage 104). After the first part of data finishes copying, and when there are more parts to copy [i.e. more N] (decision point 106), then while keeping the earlier part(s) paused, the modifications are paused to the next part of data and the next part of data is copied into the snapshot (stage 108). The pausing and copying is repeated for each remaining part to copy (decision point 106). In one implementation, in each copy phase, a largest and least frequently modified part of the data is copied earliest. In other words, those parts of data that have the smallest impact on performance are copied first.

Once all of the parts have finished copying, the application is resumed (stage 110). An example of a two-phase copy variation (i.e. where N=2) which uses the approach of FIG. 1 is described in FIG. 2 to further illustrate this concept.

FIG. 2 is a process flow diagram 120 for one implementation that illustrates the stages involved in taking a complete snapshot of data in an application in two phases by pausing parts of the application over time. While keeping an application running, modifications are paused to a first part of the data, and the first part of data is copied into a snapshot (stage 122).

While keeping modifications to the first part of data paused, modifications are paused to the remaining data that was not already copied with the first part of data, and the remaining data is copied to the snapshot (stage 124). In the second phase, the remaining data is then copied and the complete application is unpaused. In other words, the application is fully resumed once the remaining data has finished copying (stage 126).

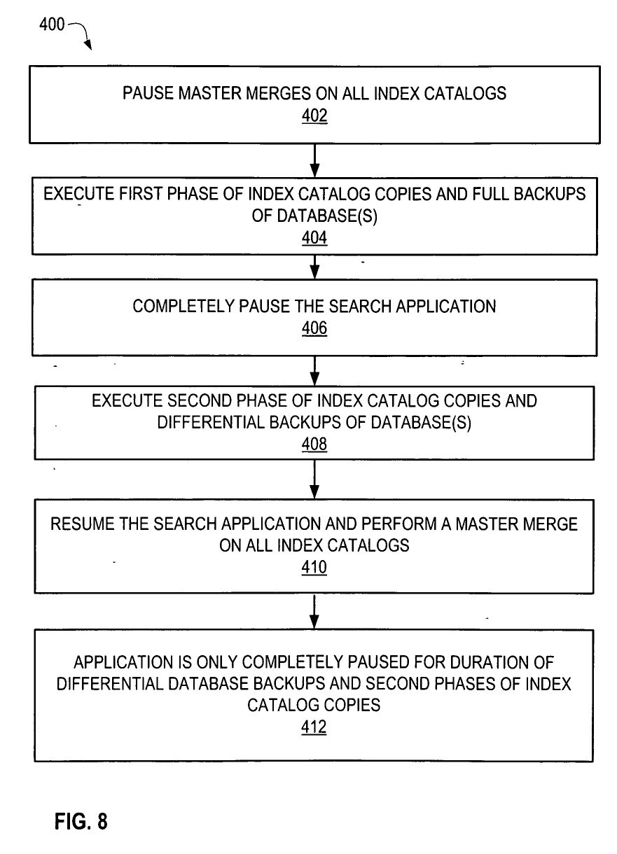

In one implementation, prior to copying the remaining data to the snapshot (prior to stage 124), a backup of one or more databases is performed using full and differential backups, and a starting point of the differential backups is synchronized with a starting point of the copying of the remaining data to the snapshot. In such a scenario, the application is completely paused right before the start of the differential backup and unpaused after all copies complete. An example of this process is described in further detail in FIG. 8.

It will be appreciated that in other implementations, there could be more than two phases in which the data is copied while the application is then paused over time. Two phases were just described in this example for the sake of illustration. Any number of phases could be used in other implementations, as was also illustrated in FIG. 1. In those implementations, modifications to one part of data are paused, and that part of data is then copied (while also keeping any previously paused parts in pause mode as well). In one implementation, the process described in FIGS. 1-2 creates a most recent copy of the application data and represents the state of the application data at time when the copy creation ends.

FIG. 3 is a process flow diagram 150 that illustrates one implementation of the stages involved in taking a complete snapshot of data in an application in multiple phases by pausing the entire application at the beginning and unpausing parts of the application over time. As noted previously, the application can be any type of application, such as a search application. The data being copied can be contained in one or more databases, database tables, files, and/or other locations.

The data to be copied is divided into N number of parts, where N is greater than or equal to 2 (stage 152). To start with, all modifications to the data are paused for an application (stage 154). A first part of the data is copied, and once that first part finishes copying, modifications are unpaused to the first part of data (stage 156). If there are more parts to copy [i.e. more N?] (decision point 158), then the next part of data is copied, and once the next part finishes copying, modifications to the next part of data are unpaused (stage 160). In one implementation, in each copy phase, a smallest and most frequently modified part of the data is copied earliest. In other words, those parts of data that have the biggest impact on performance when frozen are copied first.

Once all of the parts of data have finished copying, then the application is fully unpaused and thus is resumed (stage 162). An example of a two-phase variation (i.e. where N=2) which uses the approach of FIG. 3 is described in FIG. 4 to further illustrate this concept.

FIG. 4 is a process flow diagram 200 for one implementation illustrating the stages involved in taking a complete snapshot of data in an application in two phases by unpausing parts of the application over time. To start with, all modifications to the data are paused for an application (stage 202). A first part of the data is then copied (stage 204) and modifications are then unpaused to the first part of data after the first part of data has been copied (stage 206). When a final part of the data has been copied, then modifications to the final part of the data are unpaused (stage 208).

It will be appreciated that in other implementations, there could be more than two phases in which the data is copied while the application is then unpaused over time, as was also indicated on FIG. 3. Two phases are just described in this example for the sake of illustration. In each phase, part of the data is copied and modifications are then allowed to that part. Once the rest of the data has been copied, then the application is completely unpaused so that all modifications and functionality are restored. In one implementation, this process described in FIGS. 3-4 results in a smaller application data copy and the created copy represents the state of the application data at the start of the process.

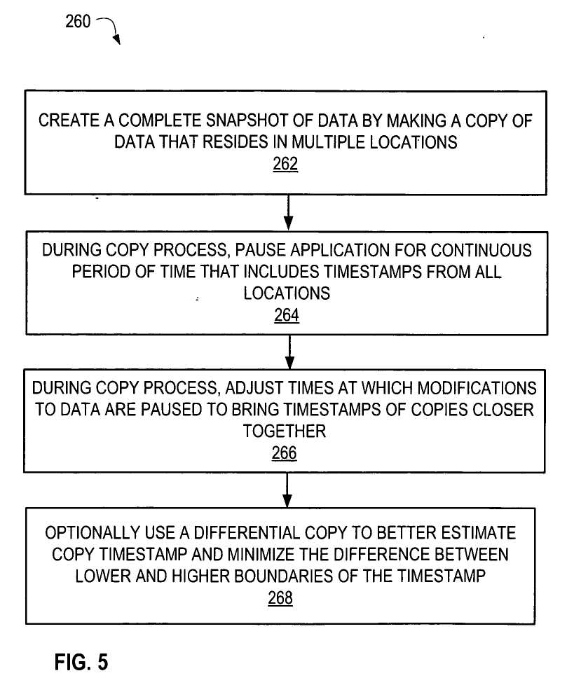

FIG. 5 is a process flow diagram 260 that illustrates one implementation of the stages involved in creating a snapshot of an application with data residing in multiple locations. In one implementation, the locations can include files and/or databases that reside on multiple servers. In another implementation, the locations can include multiple sub-directories on the same server. Note that the concepts described in FIG. 5 are shown in a series of stages for the sake of illustration, but there is no particular order intended by these techniques.

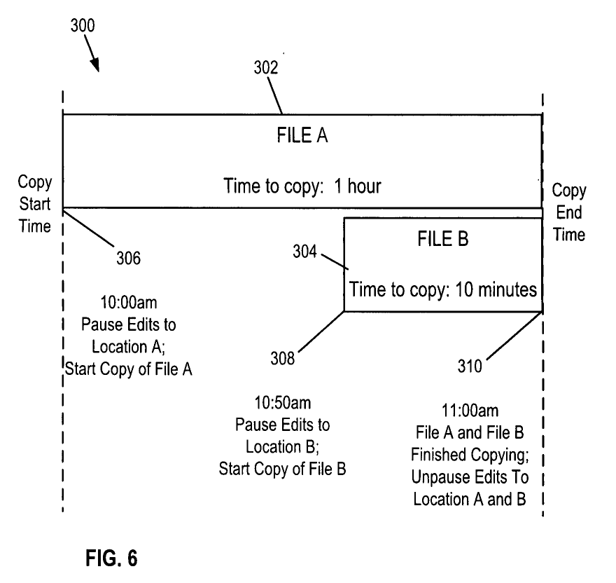

A copy process is initiated to create a complete snapshot of data for an application by making a copy of data that resides in multiple locations (stage 262). These copies of data from the data residing in multiple locations can run independently of one another. During the copy process, the entire application is paused for a continuous period of time that includes timestamps of copies from all locations (stage 264). Also during the copy process, the times at which modifications to the specific copies are paused and copied from the multiple locations are adjusted to bring the timestamps of copies from the different locations closer together so as to minimize an overall amount of time that the application is paused (stage 266). In one implementation, a particular location that will take less time to copy is not paused until a point in time that is closest to the start or end of the copying of one or more files from another location, so that a larger part of the data in the application can stay available for the longest amount of time (not have to be paused). This adjustment process is illustrated in FIG. 6 in further detail.

In one implementation, if only the lower and higher bounds of the timestamps are known, it can be sufficient to pause the application from the lowest timestamp boundary to the highest timestamp boundary, and adjust the copy processes to minimize the difference between these boundaries. In one implementation, when the timestamp of the copy is unknown and the only bounds of the copy timestamps that are known are the start and end of copy process, then a differential copy is used to estimate the copy timestamp and minimize the difference between the lower and higher boundaries of the timestamp (stage 268).

FIG. 6 is a diagrammatic view 300 of one implementation illustrating an exemplary adjustment process that can be used to adjust the times that files are copied to bring the timestamps of copies from the different locations closer together. In the example shown, there are two files that need copied from two locations. File A 302 needs to be copied from Location A, and File B 304 needs to be copied from Location B. Since File A 302 will take one hour to copy, and since File B 304 will take just 10 minutes to copy, the copying for File B can be delayed so that the copy for File A 302 and File B will finish at the same time.

Thus, in the example shown, the copy for File A 302 begins at point 306 (10:00 am), and runs for one hour (until 11:00 am). The copy for File B 304 begins at point 308 (10:50 am), and runs for 10 minutes (until 11:00 am). In this example, both files finish copying at the same time, and the application is only completely paused for the last 10 minutes. In other implementations, the copying of File B 304 could have been started at the same time that the copy of File A 302 started. In such an example, the application would only be completely paused for the first 10 minutes (as opposed to the last 10 minutes). This example just shows two files and two locations for the sake of simplicity, but in other implementations, there could be one or more files from one or more locations being used in various combinations. The point is that by adjusting the times at which the files from different locations are copied, the amount of continuous time that an application is unavailable can be minimized.

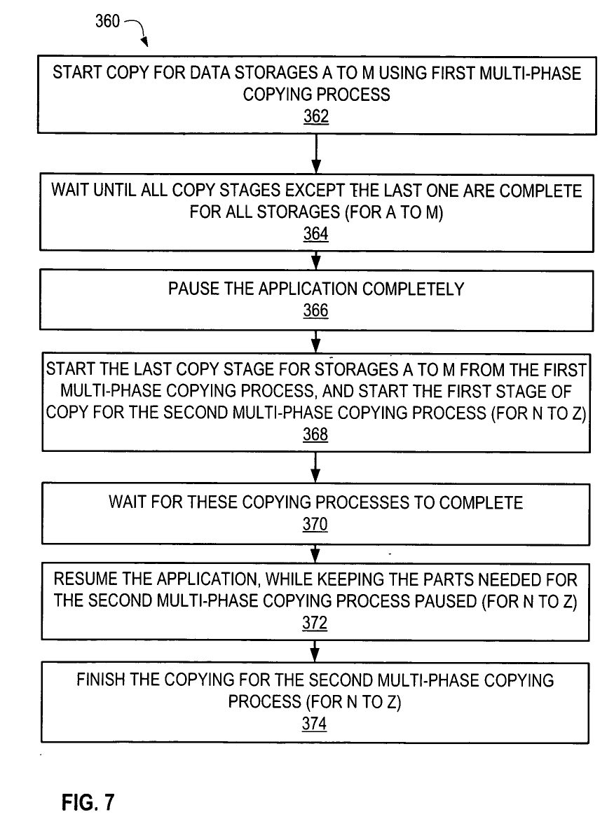

FIG. 7 is a process flow diagram 360 that illustrates one implementation of the stages involved in creating a snapshot of an application using a combination of multiple phase copying as well as multiple location copying. In other words, this implementation combines some of the techniques from FIGS. 1-4 with the techniques of FIGS. 5-6 into a single process (such as for more complicated scenarios). In this example, suppose there are data storages A-M that are copied in multiple phases as described in FIGS. 1-2, and there are data storages N-Z that are copied in multiple phases as described in FIGS. 3-4. These will herein be referred to as data storages A to M and data storages N to Z, respectively.

The copying of data is started for data storages A to M using the first multi-phase copying process (such as the one described in FIGS. 1-2) (stage 362). When all copy stages except for the last one are complete for all storages (A to M) (stage 364), the application is then paused completely (stage 366). The last copy stage is started for data storages A to M from the first multi-phase copying process, and the first stage of copy is started for the second multi-phase copying process (such as the one described in FIGS. 3-4) (stage 368). Once these copying processes have completed (stage 370), the application is resumed, while the parts needed for the second multi-phase copying process for data storages N to Z remain paused (stage 372). The remaining copying is finished for the second multi-phase copying process for data storages N to Z (stage 374).

It should be appreciated that while example storages A to M and N to Z were used for the sake of this example, that in other implementations, there could be fewer or additional storages used. These are just shown here to provide one example of how the multi-phase copying and multi-location copying techniques described herein can be combined together into an overall process.

FIG. 8 is a process flow diagram 400 that illustrates one implementation of the stages involved in taking a snapshot of data for a search application using a multi-phase copy process. The term “index catalog” as used herein is meant to include a set of files that can be queried to retrieve search results. Index catalogs can include full text indexes, which are files used by a search system to resolve full text queries. The content index and content index extension files of the master index component are considered to be the first part of the index catalog. The rest of the files are considered to be the second part of the index catalog.

Master merges are paused on all index catalogs (stage 402). The term “master merge” as used herein is meant to describe the process of consolidating newer index catalog files into a single catalog file for the purposes of optimized retrieval. The first phase of index catalog copies and full backup(s) of database(s) are executed (stage 404). The entire search application is then paused (stage 406). The second phase of index catalog copies and differential backup(s) of database(s) are then executed (stage 408). The search application is resumed and a master merge is performed on all index catalogs (stage 410). The application is only completely paused for the duration of the differential database backups and the second phases of index catalog copies (stage 412).

As shown in FIG. 9, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 9 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 9 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A method for taking a complete snapshot of data in an application in multiple phases by pausing parts of the application over time comprising the steps of:
while an application is running, pausing modifications to a first part of data and copying the first part of data into a snapshot;
after the copying of the first part of data has finished and while keeping modifications to the first part of data paused, pausing modifications to remaining data that was not already copied with the first part of data, and copying the remaining data to the snapshot; and
resuming the application once the remaining data has finished copying.

2. The method of claim 1, wherein at least some of the first part of data and the remaining data is included in a plurality of files.

3. The method of claim 2, wherein the files are full text indexes used by a search system to resolve full text queries.

4. The method of claim 1, wherein prior to copying the remaining data to the snapshot, performing a backup of one or more databases using full and differential backups, and synchronizing a starting point of the differential backups with a starting point of the copying of the remaining data to the snapshot.

5. The method of claim 1, wherein at least some of the first part of data and the remaining data is included in a plurality of tables in a database.

6. The method of claim 1, wherein when the first part and remaining data are copied, a largest and a least frequently modified part of the data is copied earliest.

7. The method of claim 1, wherein the snapshot is used as a backup for the application at a point in time.

8. The method of claim 1, wherein the snapshot is used for creating a mirrored version of the application.

9. The method of claim 1, wherein the application is a search application.

10. The method of claim 1, wherein at least some of the data is contained in files and at least some of the data is contained in one or more databases.

11. The method of claim 1, wherein prior to copying the remaining data to the snapshot, but after pausing the modifications to the remaining data, starting a copy process across multiple file locations.

12. A method for taking a complete snapshot of data in an application in multiple phases by unpausing parts of the application over time comprising the steps of:
pausing all modifications to data in an application;
copying a first part of the data;
after the first part of data has finished copying, unpausing modifications to the first part of data;
copying a final part of the data; and
after the final part of the data has finished copying, unpausing modifications to the final part of data.

13. The method of claim 12, wherein when the first part and final part of data are copied, a smallest and most frequently modified part of the data is copied earliest.

14. The method of claim 12, wherein at least some of the data includes full text indexes.

15. The method of claim 12, wherein the application is a search application.

16. The method of claim 12, wherein the snapshot is used for creating a backup for the application at a point in time.

17. The method of claim 12, wherein the snapshot is used for creating a mirrored version of the application.

18. The method of claim 12, wherein at least some of the data is contained in files and at least some of the data is contained in one or more databases.

19. The method of claim 12, wherein after copying the first part of data to the snapshot for all locations, unpausing modifications to the first part of data for all locations, and continuing the copy process across multiple file locations.

20. A computer-readable medium having computer-executable instructions for causing a computer to perform steps comprising:
initiating a copy process to create a complete snapshot of data for an application by making a copy of the data that resides in files in a plurality of locations; and
while the copy process is executing, pausing the application for a continuous period of time that includes timestamps of copies from all of the locations, and adjusting one or more times at which modifications are paused and the files are copied from the plurality of locations so that the timestamps of copies being made of the data are brought closer together, thereby minimizing an overall amount of time that the application is paused.
